(19) United States
(12) Patent Application Publication
(10) Pub. No.: US 2006/0207230 A1
(43) Pub. Date: Sep. 21, 2006

(54) Vacuum loader with filter doors

(75) Inventor: Thomas M. DeMarco, Woodstock, IL (US)

Correspondence Address: Welsh & Katz, Ltd., 22nd Floor, 120 South Riverside Plaza, Chicago, IL, 60606-3945, US

(73) Assignee: DeMarco MaxVac Corporation, McHenry, IL (US)

(21) Appl. No.: 11/435,661

(22) Filed: May 17, 2006

Related U.S. Application Data
(63) Continuation-in-part of application No. 11/162,024, filed on Aug. 25, 2005.
(63) Continuation-in-part of application No. 10/389,792, filed on Mar. 17, 2003, now Pat. No. 6,936,085.

(51) Int. Cl. B01D 50/00

(52) U.S. Cl. 55/319

(57) ABSTRACT

An improved industrial vacuum loader is equipped with a special filter door system to permit insertion, removal, inspection, and maintenance of filters during maintenance and to safely close and lock the filters during operation of the industrial vacuum loader. The industrial vacuum loader can have a solids-gas separation compartment with a tangential cyclone separator which is preferably positioned generally alongside and laterally offset from one or more filtering compartments to minimize turbulence and re-entrainment of the collected particulate material.

### CROSS REFERENCE TO RELATED APPLICATIONS

This application is a continuation-in-part of U.S. patent application Ser. No. 10/389,792 filed Mar. 17, 2003, now U.S. Pat. No. 6,936,085 issued Aug. 30, 2005 entitled “Vacuum Loader” and U.S. patent application Ser. No. 11/162,024 filed Aug. 25, 2005 entitled “Vacuum Loader”.

### BACKGROUND OF THE INVENTION

This invention pertains to machines for removing or transfer dry and wet liquid particulates, and more particularly, to an industrial vacuum cleaner, loader, pneumatic conveyor, or industrial dust collector.

In industry, voluminous amounts of particulate matter, debris, and waste are emitted during machining, foundry, milling, shipment, warehousing, assembling, fabricating, and other manufacturing operations. Particulates of dust emitted during a manufacturing operation can include metal slivers, plastic chips, wood shavings, dirt, sand, and other debris. Dust accumulates on floors, machines, packaging materials, equipment, food and personnel. Dust is carried and circulated in the air and can be injurious to the health and safety of operating personnel and other on site employees. Dust can damage, erode, and adversely effect the efficiency and operability of equipment. It can also create a fire hazard and cause explosions in some situations, such as in grain elevators. Voluminous amounts of dust can pollute the atmosphere. Dust may also impair the quality of the products manufactured.

Dust emissions are not only dangerous and troublesome, but are particularly aggravating and grievous where relatively dust-free conditions and sterile environments are required, such as in medical supply houses, the electronics industry, and in food-processing plants.

Over the years a variety of vacuum loaders, industrial dust collectors and other equipment have been suggested for removing industrial dust and debris and for other purposes. Typically, vacuum loaders, dust collectors and equipment have at least one filter compartments with one or more filters therein. Many different types of filters have been used in vacuum loaders, industrial dust collector and other equipment. In the past, access to insert and remove these filters in vacuum loaders has been through a top or bottom opening in the filter compartment, which has been difficult, cumbersome, and awkward. These prior vacuum loaders, dust collectors and equipment have met with varying degrees of success.

It is, therefore, desirable to provide an improved vacuum loader, pneumatic conveyor, or industrial dust collector which overcomes most, if not all, of the preceding problems.

### BRIEF SUMMARY OF THE INVENTION

An improved vacuum loader provides an improved industrial vacuum loader, dust collector, vacuum conveyor, and industrial vacuum cleaner that is equipped with one or more filters or one or more filter compartments positioned about one or solids-gas separators.

The improved vacuum loader has a solids-gas separation compartment for making a gross cut separation of larger particulates of dust from influent dusty air laden with particulate material. The solids-gas separation compartment has an open bottom positioned above and communicating with a hopper comprising a bin to discharge larger particulates of dust into the bin. The solids-gas separation compartment can have an inlet port connected to a primary inlet conduit and at least one outlet port for discharging a partially dedusted gas stream. At least one filtering compartment communicates with the outlet port of the solids-gas separation compartment. The filtering compartment has a top portion, a bottom portion, and at least one upright and/or lateral and/or side portion that extends upwardly between and connects the top portion and the bottom portion of the filtering compartment. The filtering compartment also has at least one filter that is disposed within an interior of the filtering compartment for filtering and removing most smaller particulates of dust comprising fines remaining in the partially dedusted gas stream. The filtering compartment has an outlet for discharging the filtered air. The bottom portion of the filtering compartment has a discharge opening that provides an open bottom which is positioned above the bin for discharging filtered particulates of dust into the bin. Advantageously, the side portion of the filtering compartment has a filter door system with a lateral access opening for accessing the filter. Desirably, the filter door system includes a side filter door that is operatively secured to the upright and/or lateral and/or side portion of the filtering compartment and communicates with the lateral access opening of the upright and/or lateral and/or side portion of the filtering compartment for selectively opening and closing said lateral access opening for ingress and egress of said filter to permit insertion, removal, inspection, and/or maintenance of the filter. The door can have a flat or curved front surface that is flush and/or aligned with an exterior surface of the upright and/or side portion of the filtering compartment.

The side door can be generally rectangular, although other shapes can be used, if desired. The side door can open right to left or clockwise, or can open left to right or counterclockwise or pulled off. Preferably, the side door is positioned opposite the outlet of the filtering compartment and is spaced laterally away from said solids-gas separation compartment. The side door can comprise an upright lateral door or a door that is positioned at an angle of inclination to the bottom portion of the filtering compartment. Desirably, the side door comprises a substantially dust impervious and imperforate barrier. Preferably, the side door comprises a metal door and at least a portion or section of the side door is positioned at a level higher than the solids-gas separation compartment. The side door can be hinged and pivotally connected to the side portion of the filtering compartment or pulled off.

In the preferred embodiment, the filter door system of the vacuum loader can include a locking bar that extends laterally and entirely across the side door for locking and securing the door in a closed position. A filter lifting or moving mechanism can be provided for each filter to lift (raise) the filter when the door is open to facilitate replacement of the filter.

In the illustrative embodiment, the vacuum loader has a frame assembly provides a support platform for receiving a hopper comprising a bin. A primary inlet conduit provides a flexible vacuuming hose or metal tubing for removing and collecting particulates of dust from particulate material in an area surrounding the vacuum loader. A vacuum pump comprising a blower and motor is mounted on the support platform and is connected to a blower line for drawing influent dusty air laden with particulates of dust from particulate material through the primary inlet conduit. A sound attenuating device is connected to the vacuum pump for attenuating and decreasing noise and vibrations from the vacuum pump. A solids-gas separation compartment is secured to the frame assembly and can comprise a tangential cyclone separator and preferably a perforated tangential cyclone separator with a foraminous cyclone wall having angular perforations. The solid separation compartment can comprise one or more louvers comprising a louvered tangential cyclone separator to facilitate separation of larger particulates of dust from the influent dusty air laden with particulate materials. The tangential cyclone separator makes a gross cut separation of larger particulates of dust from influent dusty air laden with particulate material from the primary inlet. The solids-gas separation compartment has an open bottom that is positioned above and communicates with the bin to discharge larger particulates of dust into the bin. The solids-gas separation compartment has an inlet port connected to the primary inlet conduit(s) and outlet ports for discharging a partially dedusted gas stream.

The illustrative vacuum loader has at least one filtering compartment that is spaced laterally away and offset from the solids-gas separating compartment and communicating with the outlet port of the solids-gas separation compartment. The filtering compartment has a top portion, a bottom portion, and upright side portions that extend upwardly between and are connected to the top portion and the bottom portion of the filtering compartment. Upright filters are located within an interior of the filtering compartment for filtering and removing smaller particulates of dust comprising fines remaining in the partially dedusted gas stream. The filtering compartment has an outlet for discharging the filtered air to the blower line of the vacuum pump to discharge the filtered air into the surrounding area. The bottom portion of the filtering compartment has a discharge opening providing an open bottom positioned above the bin for discharging filtered particulates of dust into the bin. Advantageously, at least one of the upright side portions of the filtering compartment comprises an accessible side portion with at least one upright rectangular lateral access opening for accessing the upright filter. The accessible side portion is preferably positioned opposite the outlet of the filtering compartment and most preferably is positioned laterally opposite from the sound attenuating device, motor, and tangential separator. Desirably, at least one upright side door is operatively connected to the accessible side portion of the filtering compartment and communicating with at least a portion of the lateral access opening of the side portion of the filtering compartment for selectively opening and closing at least the portion of the lateral access opening for ingress and egress of the filter to permit insertion, removal, or maintenance of the filter.

In the illustrative embodiment, at least one generally horizontal locking bar extends laterally and entirely across the side door. The locking bar can detachably or removably connected or pivotally connected by a hinge to the accessible side portion of the filtering compartment in proximity to the access opening. The locking bar can have a manually grippable pivotal handle operatively connected to a latch. The handle and latch can be moveable from a closed locked position for locking and securing the locking bar and the upright side door, to an unlocked open position for unlocking the locking bar and upright side door.

The novel vacuum loader or industrial vacuum cleaner efficiently removes airborne as well as settled dust (particulates) comprising particulate matter, metal slivers, plastic chips, wood shaving, dirt, sand, debris and waste from industrial plants and other locations as well as has other uses. Advantageously, the outstanding vacuum loader or industrial dust collector with a side access door in the filtering compartment is reliable, safe and effective. Desirably, the user-friendly vacuum loader or industrial dust collector with a side access door in the filtering compartment can also be movable, portable, or towable, and can be used in a stationary manner. The special vacuum loader or industrial dust collector with side access door in the filtering compartment can accommodate standard and different size and types of bins and hoppers. Furthermore, the multiple use industrial loader dust collector with a side access door in the filtering compartment provides a superb industrial vacuum cleaner, vacuum loader, and vacuum conveyor.

The vacuum loader or industrial dust collector has a solids-gas separating (separation) compartment with a tangential cyclone separator, preferably a perforated tangential cyclone separator comprising a foraminous upright curved wall plate, ring or tube or louvers, to effectively remove large particulates of dust from a dusty gas stream. In the preferred form, the perforated tangential cyclone separator has angular perforations to increase kinetic separation and removal of particulates (dust). The perforations can comprise holes, slits, slots, cuts, or passageways that are drilled, punched, spaced or otherwise formed at an angle of inclination to the exterior surface(s) of the tangential cyclone separator to increase the kinetic energy of separation of particulate from dust-laden streams. The solids-gas separator can also have a perforated, foraminous or solid a barrier wall portion comprising an impact plate separator (strike plate). The tangential cyclone separator and the impact plate separator can comprise a deflector(s) which changes the direction of flow of the incoming dusty gas stream.

The vacuum loader or industrial dust collector can have one or more filter compartments which are positioned about one or more solids-gas separating compartments. In some circumstances, it may be desirable to have an array, series or plurality of filters positioned concentrically, eccentrically or about one or more solids-gas separating compartments and in such circumstances, the filter can be arranged in a single annular filter compartment or in an array, series, or set of filter compartments.

In one preferred form, the filter (filtering) compartment can be positioned generally along side and spaced laterally away from the solids-gas separating compartment and in offset relationship thereto, rather than vertical alignment or completely above the solids-gas separation compartment. The filtering compartment has at least one filter to filter a portion of the dusty gas stream. At least one compressed air tank communicating with the filtering compartment is provided. Also, at least one air injector is operatively connected to the compressed air tank to inject compressed air with sufficient kinetic energy into the filter in the filtering compartment to help clean the filter. An intermediate conduit can be provided to pass a portion of the dusty gas stream exiting the solids-gas separating compartment to the filtering compartment. A discharge conduit can be connected to the filtering compartment to discharge the filtered portion of the dusty gas stream from the filtering compartment.

The vacuum loader greatly improves the separation of material from an air stream in a material collection chamber via a primary tangential cyclone separator. The material and air are pulled by vacuum or pushed by pressure to the tangential cyclone separator for separation of the material from the air stream so that the material can drop into the container and the separated air can flow to the air outlet port.

In an illustrated form, a hopper comprising a bin is positioned below and supports the solids-gas separation compartment and the filter compartment(s). A vacuum pump can be connected to a motor to draw (suck) influent dusty air through the inlet conduit(s) into the solids-gas separating compartment. Preferably, a sound attenuating device comprising a muffler is provided to dampen noise emitted from the motor and pump.

The vacuum loader or industrial dust collector with a tangential separator with angular perforations provides for kinetic separation of dust particulate matter from an air stream. The solids-gas tangential separator with angular perforations provides a kinetic pre-separator prior to the final filtration in the filter compartment(s) with cartridge filters (tubular filters) or other types of filters. The vacuum loader or industrial dust collector can have one, two, three or more filter compartments (filter housings). At least two of the filter compartments can be laterally spaced from and in offset relationship to the solids-gas separation compartment.

Advantageously, the vacuum loader or industrial dust collector with a perforated tangential separator can achieve unexpected surprisingly good results with excellent efficiency in the separation of particulate matter from dusty air streams. This may be attributable to greater angular kinetic separation of the dusty particulates through the angular perforations and along the perimeter or circumference of the perforated tangential cyclone separator or other solids-gas separator. It is also believed that the angular perforations provide for more efficient gross cut separation of the larger particulates of dust by the perforated solids-gas separator. Furthermore, the vacuum loader or industrial dust collector with the perforated tangential cyclone separator provide for superb separation, dedusting, and purification of the dusty gas stream to provide for cleaner emissions and better compliance with environmental laws and regulations.

In one embodiment, at least one of the filters in the filter compartment(s) comprises a tubular filter (cartridge filter, bag filter, star filter or canister filter). At least one upright compressed air tank that is positioned in proximity to the tubular filter. In some circumstances, it may be desirable to use one or more other types of filters, such as a Hepa-type filter, a bag-type filter, box-type filter, a star filter, envelope filter, flat filter, or conical filter. More specifically, each of the filtering compartments can have a filtering chamber containing at least one filter, such as a cartridge filter (canister with a tubular filter therein), a Hepa-type filter, a bag-type filter, a star filter, a box-type filter, an envelope filter, a flat filter, a conical filter, or a set of 2 to 4 or more of the preceding filters. Furthermore, each of the filtering compartments can have an acceleration or kinetic energy chamber to accelerate and/or pass the dusty gas stream with sufficient kinetic energy to remove a substantial amount of particulate of dust from the dusty gas stream before the dusty gas stream enters and passes through the filter(s). The filtering compartment can have nozzle, tubes, or ports, to inject the dusty gas stream into the acceleration chamber. One or more air injectors, shakers, vibrators, or other filter cleaning devices can be provided to periodically clean the filters. The filtering chamber can have a manual or power-operated discharge door to discharge the dust into the bin or hopper. In the illustrative embodiment, the separated and filtered particulates from the dusty air stream are discharged, collected and settled in the collection compartment of a hopper or bin positioned below the solids-gas separation and multiple filter compartments.

As used in this Patent Application, the term “dust” means particulate matter, debris and waste. The dust can comprise particulates of fiberglass, fibrous materials, powder, coal and other minerals, metal slivers and chips, sand, soda ash, steel shot, talconite pellets and other particulate material.

The term “fluid” as used herein means air and other gases and water and other liquids.

The terms “dedust” and “dedusted” as used herein mean removing a substantial amount of dust.

The term “fines” as used herein means small, minute, particulates.

The term “bulk” as used herein means the major portion of the vacuumed materials.

A more detailed explanation of the invention is provided in the following description and appended claims taken in conjunction with the accompanying drawings.

### BRIEF DESCRIPTION OF THE DRAWINGS

FIG. 1 is a perspective view of an industrial dust collector comprising a vacuum loader having a filter compartment with side access doors in accordance with principles of the present invention;

FIG. 2 is a left side view of the industrial dust collector (vacuum loader);

FIG. 3 front view of the industrial dust collector (vacuum loader) with a diagrammatic illustration of the side access doors;

FIG. 4 is a back view of vacuum loader;

FIG. 5 is a top plan view of view of the industrial dust collector (vacuum loader);

FIG. 6 is an enlarged fragmentary perspective view of the access openings of the filtering compartment with the doors open illustrating the left upright tubular filter held in place by a pair of left filter braces in a closed position and illustrating a pair of right filter braces being manually pivoted to a partially open position; and

FIG. 7 is an enlarged fragmentary perspective view of the access openings of the filtering compartment with the doors open illustrating the left upright tubular filter held in place by a pair of left filter braces in a closed position and illustrating a pair of right filter braces in an open position for inserting or removing the right upright tubular filter.

### DETAILED DESCRIPTION OF THE INVENTION

A detailed description of the preferred embodiments and best modes for practicing the invention are discussed herein.

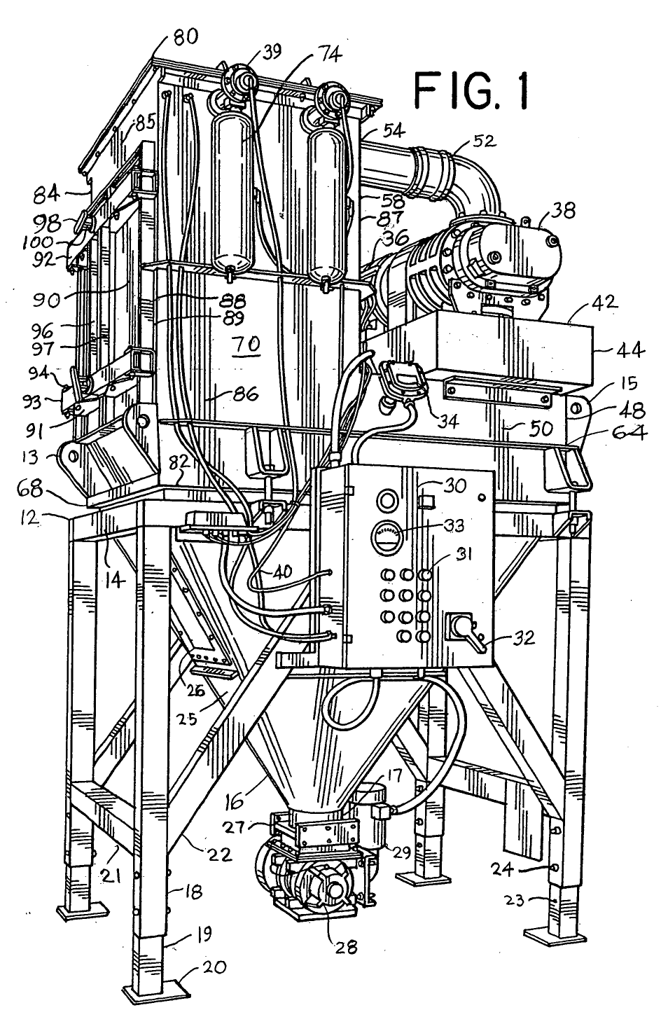

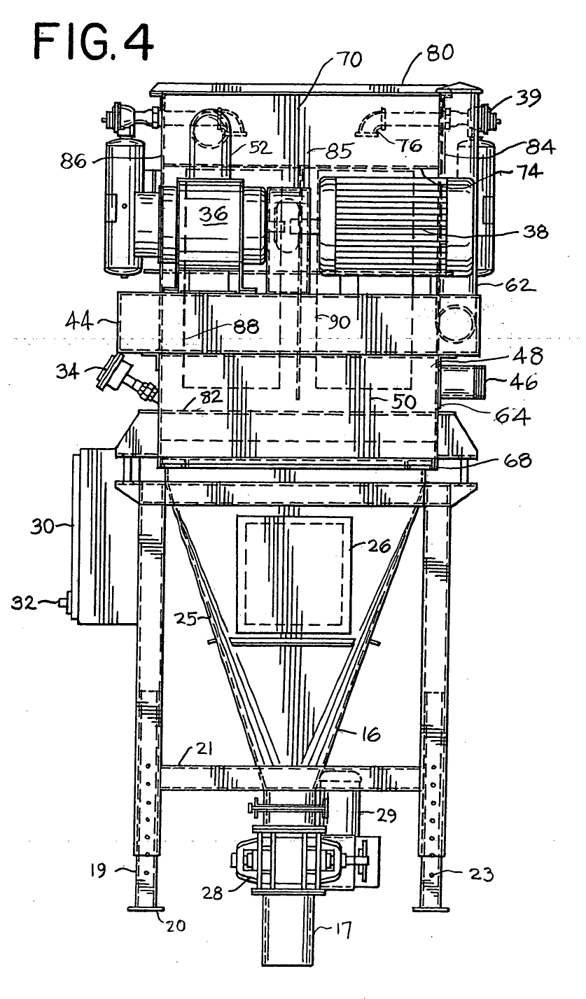

An industrial dust collector 10 (FIGS. 1-5) provides a heavy-duty vacuum-operated machine, industrial vacuum cleaner, vacuum loader and vacuum conveyor or pneumatic conveyor to efficiently remove, effectively collect, and safely dispose or convey (transfer) particulate matter, debris, and waste. The industrial dust collector can be made of steel or other metal. Other materials can be used. The vacuum loader or industrial dust collector 10 can have a frame assembly 12 with a base 14 which provides a support platform and a cradle for receiving a hopper 16 comprising a bin such as an end dump hopper. The bin (hopper) has at bottom end with a downwardly facing discharge pipe and conduit providing a hopper outlet 17. In the illustrative embodiment, the hopper comprising a bin is positioned below and supports the solids-gas separating (separation) compartment, as well as supports the filtering compartment(s). The bin has a collection compartment or chamber to receive and collect the large particulates of dust removed by the solids-gas separator and the smaller particulates (fines) removed by the filters of the multiple filter compartments. The bin can comprise a stationary bin, a moveable bin, a portable bin, and/or a towable bin. Preferably, the bin has a lower portion with a manual or power-operated slideable valve to discharge the collected particulates (particles) of dust from the bin.

The frame assembly and hopper can be equipped flanged plates 13 and 15 (FIG. 1) with openings therein and/or with forklift-channels for receiving and being moved by tines of a forklift truck. The frame assembly can have telescoping upright legs 18-19 with feet 20 and support members comprising lateral bars 21 and diagonal braces 22. The telescoping legs can be extended or retracted to adjust the height of the legs and frame assembly. The legs have bolt holes 23 that receive bolts 24 and nuts to securely bolt the legs at the desired height. The frame assembly can also comprise a skid with a coupling or tow bar for coupling and attachment to a railway car, truck or other vehicle. Pneumatically-operated expansion bellows can be positioned on bellows support pads of the frame assembly to move the top of the bin flush into sealing engagement against a gasket or seal on the underside of the support platform. Wheels or casters can be mounted on the underside of the feet to enable the frame assembly and industrial dust collector to be mobile, portable, moveable, and towable. The downwardly inclined frustoconical portion 25 of the bin 16 can have a discharge door 26, a cutoff gate 27, a rotary airlock valve 28 operatively connected to and controlled by a motor 29. A control panel 30 can be mounted on the frame assembly. The control panel can have buttons 31, control knobs 32, and gauges 33 to control, activate, and deactivate a high level control 34 comprising an indicating gauge with a display screen, the motor 29 which drives and controls the rotary airlock valve 28, a blower motor 36, vacuum pump 38, air injectors 39, etc. via wires 40 or conduits. The control panel can also be connected to a sensor and limit switch in the bin to automatically shut off the air blower or blower motor when the discharged collected dust in the bin has reached a preselected level. The control panel, which when energized and activated, provides voltage and power for the operation of a solenoid valve connected to a vacuum breaker, as well as solenoid air valves connected to the filter cartridge's reverse pulse cleaning circuit. The electrical control panel can be equipped with: a vacuum pump gauge, vacuum differential gauges, a filter differential gauge, switches, start/stop push buttons, a cartridge filter cleaning pulse timer circuitry package, indicating lights, relays, and other components, gauges, and devices. The vacuum loader can also have a pneumatic circuit and valves for operating a vacuum breaker and a reverse air pulse circuit.

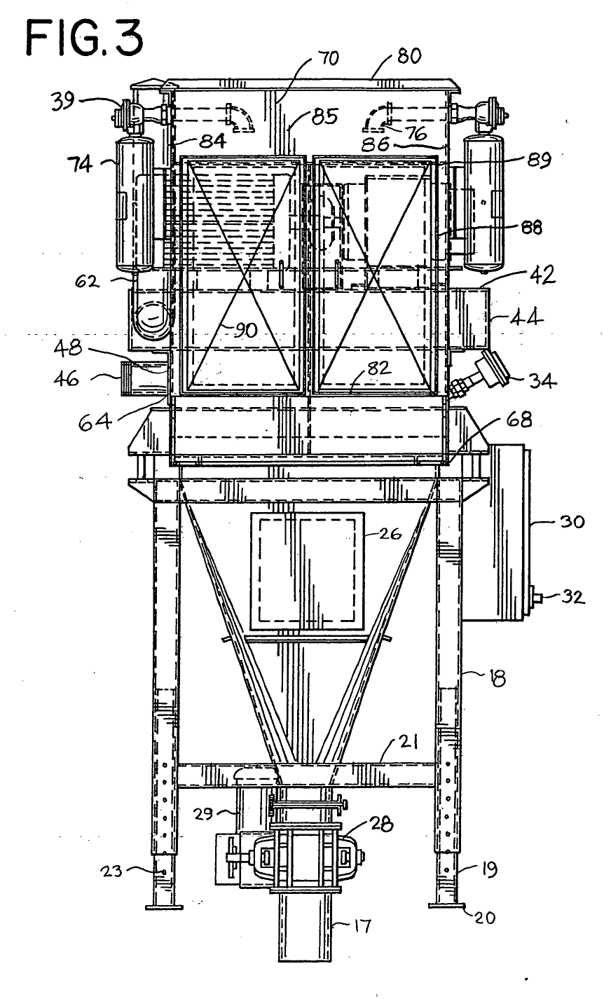

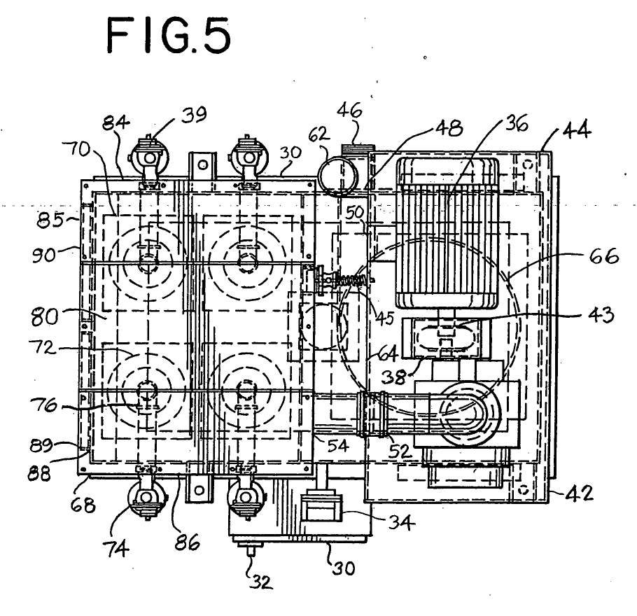

The electric motor providing a blower motor 36 (FIG. 1) and vacuum pump 38 comprising a compressor, air blower, turbine, regenative (regen), or fan can be mounted on a support surface comprising support platform 42 of a sound attenuating device 44. The blower motor is coupled and operative connected to the vacuum pump by a drive coupling 43 (FIG. 5). The vacuum loader can also be equipped with a vacuum breaker 45 providing a relief valve. The vacuum pump (air blower) is operatively connected to and driven by the motor 36 such as by drive belts. The vacuum pump creates a vacuum (suction) to draw dust and direct influent dusty air (air laden with particulates of dust) comprising the dusty gas stream through one or more inlet conduits, such as through a primary inlet conduit 46 (FIGS. 3-5) with or without a metal pipe, tubing or manifold, that provides a flexible vacuum hose and can have a secondary inlet conduit. The primary inlet conduit and optional secondary inlet conduit provide at least one material inlet port into a solids-gas separation (separating) compartment 48 containing one or more solids-gas separators 50. A flexible, elongated intake hose or metal tubing, with an optional nozzle, can be connected to the intake conduit to facilitate collection of the particulate material. In the illustrative embodiment, the primary inlet conduit is tangential to the solids-gas separation compartment and the solids-gas separator contained therein. The inlet conduit directs the flow of the influent dusty gas streams inwardly to create a turbulent or swirling action of the dusty gas streams in the solids-gas separation compartment.

The air blower can be connected by an overhead blower line 52 (FIG. 1) which communicates with discharge outlet conduit (filter outlet) 54 of the upper chambers (upper portions) of the filter (filtering) compartment 58 (filter housing). The air blower can also be operatively connected to and communicate with an exhaust pipe (exhaust stack) to provide a blower discharge outlet and exhaust to emit the dedusted purified clean gas stream (air) to the surrounding area or atmosphere.

### Silencer Base Assembly

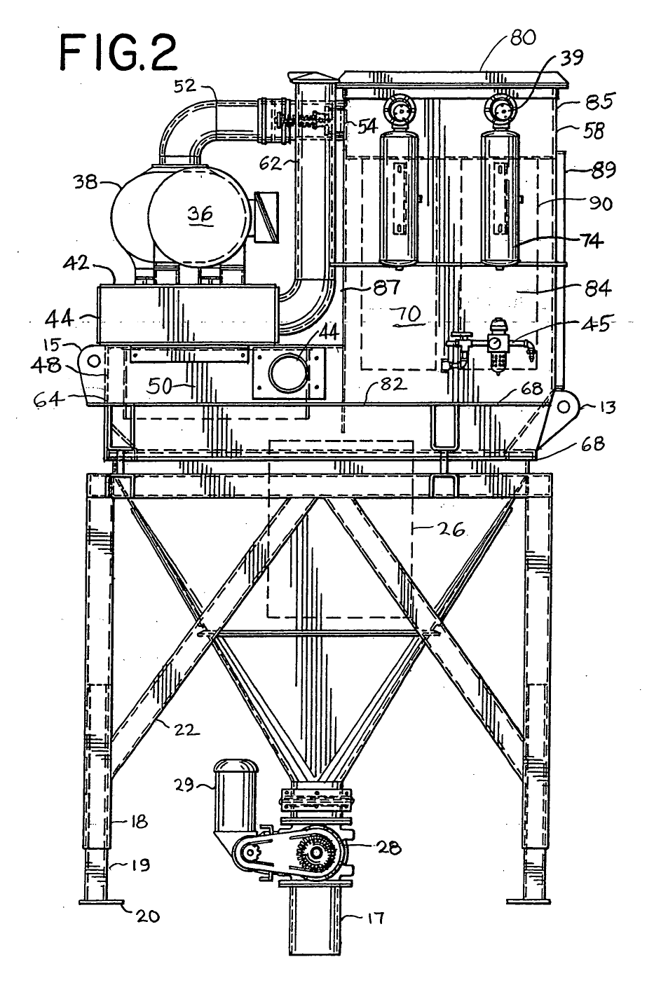

The vacuum loader can be equipped with a sound attenuating device 44 (FIGS. 1-4) comprising a muffler with an upright overhead intake 62 (FIG. 2) that can be connected to the air blower and the exhaust pipe to attenuate, muffle, suppress, and decrease noise and vibrations from the air blower (vacuum pump) and motor, and dampen the noise and sound of the purified gases passing and being discharged through the exhaust pipe. Preferably, the muffler of the sound attenuating device comprises a silencer base as described in applicant's U.S. Pat. No. 4,786,299 which is hereby incorporated by reference.

In the preferred embodiment, the muffler comprises a silencer base muffler assembly 44 (FIGS. 1-4) that provides a sound abatement control unit to muffle, quiet, and abate the noise and sound level of the purified clean filtered fluid exiting the filtering compartment as well as to help suppress operational noises from the vacuum pump. The muffled purified air can exit through a vent pipe and vent flap to the atmosphere. The muffler assembly preferably has a silencer base platform or floor and a vent flap to the sound attenuating chamber and a box-like muffler rectangular support housing positioned in proximity to and along the side of the filtering compartment and the vacuum pump. The muffler support housing can have an upper flat or planar support surface comprising a top plate and ceiling of the silencer base to support and dampen the vibrations of the vacuum pump. The internal composite sound attenuating chamber can have an internal, reverse direction, zigzag channel which communicates with the filtering unit to vary the direction of flow of the filtered fluid in a zigzag, sinusoidal, or square wave flow pattern. Acoustical metal, wooden, or plastic muffler baffles in the channels are covered with sound insulating material, such as acoustical sound absorption foam, mineral wool, or fiberglass insulation, to dampen and decrease the noise of the filtered fluid passing through the channel to safe and comfortable levels before it is discharged from the vacuum loader through an exhaust pipe. The acoustical baffles include upward composite muffler baffles and downward composite muffler baffles. The upward muffler baffles of the muffler housing can be cantilevered to and extend upwardly from the floor of the muffler housing to a position spaced below the ceiling of the muffler housing. The downward baffles of the muffler assembly can be cantilevered and extend downwardly from the ceiling of the housing to a position spaced above the housing floor. The upward baffler are positioned and spaced between the downward baffles. The composite downward and upward baffles can provide gas impervious, air impermeable, lateral barriers which extend laterally across and connect the sides of the muffler housing to block and deflect the longitudinal flow of filtered, dedusted, purified clean fluid and concurrently direct the clean fluid in the reverse direction channel so as to reduce the noise of the filtered, dedusted, purified clean fluid passing through the sound attenuating chamber.

### Solids-Gas Separation Compartment

The solids-gas separation compartment 48 (FIGS. 1-5) contains one or more solids-gas separators, preferably comprising a tangential cyclone separator 64 with an open bottom providing a circular or circumferential bottom outlet 66 (FIG. 5) providing an outlet port about its circular edge and periphery to discharge larger particulates of dust into the bin. The tangential cyclone separator preferably comprises a perforated plate or foraminous tangential cyclone separator, such as described in applicant's U.S. Pat. No. 6,936,085 which is hereby incorporated by reference. The tangential cyclone separator can have angular perforations, such as described in applicant's U.S. patent application Ser. No. 11/162,064 which is hereby incorporated by reference. The tangential cyclone separator can comprise a louvered tangential cyclone separator comprising a circular array of aliquotly spaced upright slats providing louvers.

The vacuum loader or industrial dust collector can have at least one perforated foraminous solids-gas separation (separating) compartment containing at least one perforated foraminous solids-gas separator. Desirably, the solids-gas separator provides gross separation to remove large particulates (particles) of dust from an influent dusty gas stream (e.g. dust laden air) to attain a grossly separated effluent dusty stream having a lower concentration of particulates of dust by weight than the influent dusty stream. The solids-gas separator can comprise a perforated tangential cyclone separator with angular perforations. The tangential cyclone separator with angular perforations provides an offset deflector cyclone for kinetic separation of material from the influent dusty stream (air flow). The industrial dust collector with a perforated tangential cyclone separator with angular perforations provides an effective industrial vacuum cleaner, vacuum loader and conveyor. The solids-gas separator can also have a barrier wall portion comprising a perforated, foraminous or solid impact plate, ring, tube or louvers. The solids-gas separating compartment has an inlet conduit (intake) to feed the influent dusty stream to the perforated tangential cyclone separator. The solids-gas separating compartment also has a separator-outlet (exit) conduit to discharge the partially dedusted, grossly separated, effluent dusty stream from the perforated foraminous solids-gas separating compartment.

As indicated above, the perforated plate tangential cyclone separator preferably comprises a perforated foraminous plate tangential entry centrifugal cyclone separator with angular perforations to partially dedust and separate the carry over dust from the grossly separated fluid stream. The perforated plate tangential cyclone separator with angular perforations minimizes turbulence, clogging and re-entrainment of particulates. The perforated tangential entry cyclone separator with angular perforations can have a cyclone housing, with an upright vertical perforated foraminous wall comprising an upright vertical curved circular perforated foraminous cyclone wall plate, ring, tube, or louvers, with a circular exterior surface and a circular inner surface that surround a cyclone interior about a central cyclone portion. A cyclone inlet can be connected to and communicate with the bulk separator-fluid-outlet hose to receive the grossly separated fluid stream and carryover dust from the bulk separator-fluid-inlet hose. The cyclone inlet preferably comprises a tangential intake conduit which extends linearly and outwardly from the circular surface of the annular wall of the cyclone housing and communicates with the cyclone interior.

The angular perforations can comprise an array, set, series, pattern, curved rows, parallel rows, staggered rows, or aligned rows of vent holes, through holes, apertures, passageways, radial openings, slanted openings, slits, slots, offset holes, or fluid outlet ports. The holes can be circular, oval, elliptical, square, triangular, rectangular, or polygonal and are drilled, punched, or otherwise formed to extend entirely through the perforated foraminous wall of the perforated cyclone wall plate radially outwardly at an angle of inclination to the exterior and interior surfaces (walls) of the perforated tangential cyclone separator. The angular perforations can be positioned at an angle of inclination ranging from greater than 0 degrees to less than 90 degrees, such as about 5 degrees to about 85 degrees, preferable from about 15 degrees to about 75 degrees, and most preferably from about 30 degrees to about 60 degrees relative to the exterior, outer or inner surface of the upright curved cyclone wall plate. Some or all of the angled perforations can be positioned at an angle of about 45 degrees relative to the exterior surface (wall) of the perforated tangential separator. The angular perforations can be of equal sizes or unequal sizes and can be positioned complementary to each other, aligned or arranged in a matrix, staggered array, offset arrangement, in groups, sets, series, and/or in a symmetrical, asymmetrical, or uniform pattern. Some or all of the perforations can be parallel, diverge, or converge, or be positioned at an angle of inclination relative to each other, the angular perforations can have a maximum span or diameter of about 1/64 to about one (1) inch. There can be from about one (1) to about 144 angular perforations per square inch of the perforated cyclone wall plate.

The perforated area of the angular perforations of the perforated tangential separator provides an open area that can extend from greater than 0 degrees to 360 degrees, preferably 60 to 300 degrees, and most preferably 180 degrees. The perforated area of the angular perforations can also be spaced from the cyclone inlet and tangential intake conduit at a spacing ranging from greater than 0 degrees to less than 360 degrees, such as from 30 to 330 degrees, preferably 25 to 330 degrees, and most preferably 90 to 270 degrees. The angular perforations and open area can occupy 3% to 95% and most preferably from 10% to 65% of the perforated area (portion) of the upright curved cyclone wall plate.

The angular perforations provide for more thorough kinetic separation of the particulates (material) from the air or fluid stream. The majority of the material on the inside of the perforated tangential cyclone separator and air or other fluid is kinetically separated in the perforated tangential cyclone separator with angular perforations and flow radially outwardly through the angular perforations. This arrangement also preliminarily vents (prevents) the air or other fluid within the cyclone walls of the perforated tangential cyclone separator with angular perforations so as to decrease turbulence outside the perforated tangential cyclone separator with angular perforations and the material collection chamber below.

The perforated plate tangential entry cyclone separator with angular perforations can have a set of perforated, foraminous or solid directional vanes or louver slots which can provide angular perforations that extend between the cyclone inlet and the cyclone outlet openings to change and vary the direction of flow of the fluid stream and enhance kinetic separation of the dusty particulates from the fluid. The directional vanes can help minimize and prevent clogging, backup and piling up of particulates in the perforated tangential separator. The directional vanes can include a pair of central vanes with parallel portions with angular perforations. The central vanes can be connected to and communicate with the cyclone outlet openings. The directional vanes can have curved portions with angular perforations. The directional vanes can also include an arcuate baffle comprising a convex barrier with angular perforation which can be spaced from the cyclone inlet and the outlet openings. The convex barrier is positioned inwardly of the central vanes. The directional vanes can further include a concave deflector can have an outlet end connected to the outlet openings and an inlet end which can be connected to the inner surface of the annular wall of the cyclone housing. The vanes can also have beveled or inclined ends with angular perforations to enhance particle separation.

The industrial dust collector with a perforated tangential cyclone separator with angular perforations provides a heavy duty, vacuum operated machine, industrial vacuum cleaner, vacuum loader, and conveyor to efficiently remove, effectively collect, and safely dispose of particulate matter, debris, and waste. The perforated tangential cyclone separator with angular perforations makes a gross cut and partially dedusts the dusty influent air, gas and/or liquid. The perforated tangential cyclone separator with angular perforations can be orientated and arranged to direct and blow the dusty air, gas and/or liquid counterclockwise or clockwise, so that the dusty air, gas and/or liquid flows downwardly through the solids gas separation compartment, laterally through the upper portion of the bin or hopper, and upwardly through a single filter compartment or multiple filtering compartments. Instead of or in addition to the perforated tangential cyclone separator, the solids-gas separator can comprise a perforated, foraminous curved barrier wall or perforated, foraminous angled impact plate separator (strike plate). The perforated tangential cyclone separator, curved barrier wall, and impact plate separator all provide a deflector(s) comprising an impingement surface(s) with angular perforations which change the direction of the incoming dusty gas stream and grossly separates and removes the larger particulates of dust from the influent dusty gas stream.

The perforated tangential cyclone separator with angular perforations can be short with a height of about twice the diameter of the inlet hose, i.e. the ratio of the height of the perforated tangential cyclone separator with angular perforations to the diameter of the inlet hose or cyclone inlet can be 2:1, e.g. a 12 inch high perforated tangential cyclone separator with angular perforations is used with a 6 inch inlet hose. In contrast, conventional tangential cyclones with cones are relatively tall with a height of about ten times (10 fold) the diameter of the inlet hose. The vacuum loader can have a height ranging from 2.5 feet to 3 feet with a 2, 4 or 6 inch diameter inlet hose, and a perforated tangential cyclone separator height with angular perforations ranging from 4 inches to 30 inches. The perforated tangential cyclone separator can have a wall thickness of about 0.2 inch to about 1 inch. Other dimensions for the tangential cyclone separator can also be used in some circumstances.

While a perforated tangential cyclone separator with angular perforations is preferred, in some circumstances it may be desirable to use other types of solid-gas separators, such as a solid imperforate strike plate, baffles, etc.

### Filter Compartment

The partially dedusted gas stream can exit the solids-gas separating compartment through the bottom outlet or fluid outlet ports (perforations, apertures, holes, passageways, etc.) of the solids-gas separating compartment and pass (flow) upwardly through the open bottoms (filter compartment-inlets) 68 (FIGS. 1-5) of one or more filter compartments 70 or multiple filter compartments, such as described in applicant's U.S. Pat. No. 6,569,217 which is hereby incorporated by reference. Each filter compartment contains one or more filters 72 (FIGS. 5-7), preferably a set, series, or array of filters, such as four upright tubular filters. The partially dedusted gas stream of air can pass (flow) upwardly and be filtered by filters in the filter compartment to remove most of the remaining smaller particulates (fines) of dust in the dusty stream. The filtered dedusted air can pass (flow) upwardly and exit and be discharged from the filter compartments through the filter outlet 54 (FIG. 1). The filtered air can be drawn through the blower line 52 by the vacuum pump (blower) 38 and can be discharged to the surrounding area and atmosphere by the exhaust pipe 62.

The open bottoms of the filter compartments can provide filter discharge openings to discharge the filtered and removed particulates of dust (fines) into the bin. The filter (filtering) compartments can have horizontal floors comprising normally closed, manual or power-operated, discharge hatches, flaps, door or valves which can be connected by suitable electric, air or hydraulic powered by a external motor, compressed air tanks or hydraulic pumps.

The filter compartment can have a filter chamber that contains a plurality, set, or array of canister filters (annular, tubular or cartridge filters) 72 (FIGS. 5-7). The partially dedusted gas stream can flow upwardly, annularly, and laterally through each filter of the filter compartment to remove substantially all the remaining particulates of dust. In the illustrative embodiment, the filter compartment contains a set of four canister filters which are positioned in a circular array. While the preceding arrangement is preferred for best results, more or less filters or different types of filters can be used, if desired. The set of filters in the filter compartment remove the fines (minute fine dust particles) and substantially all the remaining particulates of dust in the dusty gas stream flowing through the filter compartment to produce a dedusted purified gas (air) stream.

A discharge outlet conduit 54 (FIG. 1) can be connected to and communicate with the upper clean air chamber (plenum) of the first filtering (filter) compartment to provide an outlet and passageway through which the purified, dedusted and filtered air is drawn from the first filtering compartment via the blower line 52 into the vacuum suction pump (air blower) and muffler for discharge via the exhaust pipe to the atmosphere or area surrounding the industrial dust collector.

Reverse pulse filter cleaners comprising air injectors 39 (FIGS. 1-5) can be mounted and extend to the interior of the upper air chamber of the first filtering compartment to periodically inject intermittent blasts comprising pulses of compressed clean air upon the inside (interior) of the filters to help clean the filters. The injectors can be connected by pneumatic tubes or conduits to an air supply source 74, such as compressed air tanks comprising compressed air canisters, or an auxiliary compressor. In the illustrative embodiment, there is a circular array or set of four upright compressed air canisters (compressed air tanks) 74 mounted about the exterior surface of the cylindrical upright wall of the filtering compartment and there is a circular set or array of four downwardly facing, overhead air injectors 76 (FIGS. 3-5) positioned above the centers of the filters and connected to the compressed air canisters to sequentially inject pulses of compressed air into the center of the tubular filters to shake loose the dust collected, accumulated, or the outside of the filter walls. More or less air injectors and compressed air canisters can be used. While the illustrated arrangement is preferred for best results, a different arrangement can be used, if desired. The filtered removed dust collected and accumulated on the bottom of the first filtering (filter) compartment can be discharged into the bin when the blower is turned off or by actuation of the control panel and/or when the discharge door or bottom of the first filter compartment is open.

The vacuum loader or industrial dust collector can have multiple filter (filtering) compartments with two or more filter (filtering) chambers. As indicated above, the lower filtering chamber can contain one or more filters (cartridges, bags, or canisters) to filter smaller particulates of dust from a first portion of the grossly separated effluent dusty stream from the solids-gas separating compartment to provide a filtered stream having a lower concentration of particulates of dust by weight than the grossly separated effluent dusty stream. The array, set or series of air injectors are operatively connected to the compressed air tank(s) to intermittently inject pulses or blasts of compressed air with sufficient kinetic energy to the set of filter(s) in the filtering compartment lower chamber to help clean the set of filters in the filtering compartment. Advantageously, each filtering compartment(s) are positioned generally along side and is spaced laterally away from the solids-gas separating (separation) compartment and in offset relationship thereto, rather than in vertical alignment or completely above the solids-gas separating compartment. Each filter (filtering) compartment can have a pressure (vacuum) relief valve. An intermediate conduit can communicate with the separator-outlet conduit and the filter (filtering) compartment to pass the portion of the grossly separated effluent dusty stream from the solids-gas separating compartment to the filtering compartment. A discharge (outlet) conduit can be provided to discharge the filtered stream from the filtering compartment.

In the preferred embodiment, the air injectors are positioned at an elevation above the filters, pump, motor, and tangential cyclone separator. While tubular filters are preferred for more effective filtering, in some circumstances it may be desirable to use one or more other types of filters, such as Hepa-type filters, bag-type filters, box-type filters, envelope filters, flat filters, or conical filters. Other types of filters can also be used, if desired.

The partially dedusted, grossly separated dusty air can exit from the bottom edge or fluid outlet port(s) of the tangential cyclone separator and pass upwardly through the filter compartment. The filters in the filter compartment remove most of the remaining small particulates comprising fine particles (fines) of dust from the dusty stream to provide a purified, dedusted stream of cleaner air which is drawn through the blower line by the air blower (vacuum pump) and is discharged through the outlet stack comprising the exhaust pipe. The air injectors cooperate with the compressed air tank(s) for intermittent reverse air-pulse cleaning of the filter(s) in the filter compartment(s) while vacuuming during operation of the industrial dust collector. The collected filtered fine particles of dust (fines) are discharged through the open bottom of the filter compartment into the bin.

As indicated previously, the filtering (filter) compartment is preferably positioned along side and spaced laterally rearwardly and away from the solids-gas separation compartment and in offset relationship thereto, rather than vertically above the solids-gas separation compartment. The open bottom portion of the filtering compartment(s) can provide one or more sub compartment(s) (one or more chambers) inlet(s) openings for entrance of the partially dedusted stream of air, gas and/or liquid from the tangential cyclone separator.

The inner central portion of the filtering (filter) compartment provides a filter chamber(s) that can contain at least one filter to filter, dedust, and remove substantially all of the remaining particulates of dust in the upwardly flowing stream of dusty air and/or liquid in the filtering compartment. The filtering compartment can contain one or more concentric set or series of tubular filters. The filtering compartment can have a set or series of air injectors which are connected by compressed air lines and conduits to compressed air tank(s) to sequentially inject intermittent pulses of air on the filters to clean one or more filters. In some circumstances, it may be desirable to use other types of filter cleaning equipment, such as manual or powered mechanical shakers and vibrators.

### Operation of Vacuum Loader

In operation, air laden with entrained particulates of debris, waste and other dust is drawn by the blower through the intake conduits into the tangential cyclone separator in the solids-gas separation compartment. The tangential cyclone separator (cyclone) swirls the dusty air tangentially along the inside surface of the gas-solids separation compartment and ejects the effluent partially dedusted air upwardly into the filter compartment. Preferably, the tangential entry cyclone separator kinetically and centrifugally separates most of the carryover dust from the bulk separated fluid. The cleaner, centrifugally cycloned partially dedusted air can be drawn (sucked) radially outwardly through angular perforations of the cured upright cyclone wall plate of the perforated plate tangential cyclone separator, where it flows upwardly to be filtered by the high efficiency cartridge filters. The filters can filter the particulates (dust) to under 1 micron, preferably at an efficiency of about 99.5% at about 0.33 microns. Collected dust on the surface of the filters can be reverse air-pulse cleaned by variable pulse speed, air pulse injectors. The removed particulates are discharged by gravity downwardly into the bin through the bottom outlet of the solids-gas separation compartment.

The vacuum loader can incorporate a unique two stage separator system which provides for highly effective separation of the vacuumed dust-laden product (wet, dry, or fibrous, as well as liquids and slurries) thereby providing customers with versatile, effective, and substantially trouble-free vacuum cleaning and loading. The vacuum loader can provide capabilities for long distance vacuuming of very light fibrous materials, such as fiberglass to lumps, chunks, soda ash, steel shot and talconite pellets. The vacuum loader can comprise a direct conveyor belt loader for low overhead clearance applications.

As previously discussed, the vacuum loader provides an industrial vacuum cleaner, dust collector, and vacuum conveyor for removing particulate material. The vacuum loader has a frame assembly for receiving a hopper comprising a bin. The frame assembly provides a support platform. A primary inlet conduit provides a flexible vacuuming hose or metal tubing for removing and collecting particulates of dust from particulate material in an area surrounding the vacuum loader. A vacuum pump comprising a blower and motor is mounted on the support platform and is connected to the blower line for drawing influent dusty air laden with particulates of dust from particulate material through the primary inlet conduit. The sound attenuating device is connected to the vacuum pump for attenuating and decreasing noise and vibrations from the vacuum pump.

The solids-gas separation compartment is secured to the frame assembly and preferably comprises a tangential cyclone separator for making a gross cut separation of larger particulates of dust from influent dusty air laden with particulate material from the primary inlet. The solids-gas separation compartment has an open bottom that is positioned above and communicates with the bin to discharge larger particulates of dust into the bin. The solids-gas separation compartment has an inlet port connected to the primary inlet conduit and one or more outlet ports for discharging a partially dedusted gas stream.

The vacuum loader with the bulk separator, tangential cyclone separator and filtering compartment effectively, efficiently, and safely collect and discharge fibers, dust laden liquids, dry dusty materials, contaminated sand and soil, slivers, chips, granular material, pellets, chunks, powders, slurries, liquids, debris, coal and other minerals, soda ash, metals, dense and heavy material, such as steel shot and talconite pellets, waste, and other particulate material. Additionally, the vacuum loader provides a total vacuuming system which is under continuous negative pressure from the vacuuming hose inlet port to the vacuum producing pump inlet port during all vacuum cycles throughout the operating day and shift.

### Filter Doors

As shown in FIGS. 1-5, at least one filtering (filter) compartment 70 is spaced laterally away and offset from the solids-gas separating compartment 48 and communicates with the outlet port 66 (FIG. 5) of the solids-gas separation compartment. The filtering compartment preferably can have an imperforate generally flat, planar or domed top portion 80 (FIGS. 1-5), a bottom portion 82, and upright lateral side portions 84-87 that extend generally vertically between and connect the top portion 80 and the bottom portion 82. The upright side portions 84 comprise a motor-facing side portion 87 facing the solids-gas separating compartment and the sound attenuating device, an accessible side portion 85 positioned opposite the motor-facing portion, and opposite facing injector supporting side portions 84 and 86 extending between and connected to the motor-facing side portion and the accessible side portion. In some circumstances, it may be desirable that the upright lateral side portion comprise a curved upright portion that has an annular and/or circular cross-section.

In the preferred embodiment, an array of upright tubular filters 72 (FIGS. 5-7) comprising a series of four cartridge filters are positioned within an interior of the filtering compartment for filtering and removing most smaller particulates of dust comprising fines remaining in the partially dedusted gas stream. Reverse pulse filter cleaners 39 (FIGS. 1-5) comprising downward facing air injectors 76 (FIGS. 3-5) are mounted on the injector side portions 84 and 86 of the filtering compartment and extend into to the interior of the filtering compartment for periodically injecting intermittent blasts comprising pulses of compressed air upon the upright tubular filters to help clean the upright tubular filters. An air supply source 74 comprising compressed air tanks or air canisters are mounted on the injector side portions of the filtering compartment and are pneumatically connected to the air injectors for providing compressed air to the reverse pulse filter cleaners. As previously indicated, the motor-facing portion 58 of the filtering compartment having an outlet 54 (FIG. 1) that communicates with the blower line 52 for discharging the filtered air to the blower line into the vacuum pump 38 to discharge the filtered air into the surrounding area. The bottom portion of the filtering compartment having a discharge opening 68 providing an open bottom positioned above the bin for discharging filtered particulates of dust into the bin.

Desirably, the filtering compartment is equipped with a filter door system comprising an accessible side portion 85 (FIGS. 1-7) with upright door frames 89 which provide and define upright, similar size, laterally aligned, rectangular lateral, side access filter openings 88 for accessing the upright tubular filters. Advantageously, the filter door system has a set of laterally aligned, similar size, upright lateral side access filter doors 90 that are pivotally connected and hinged to the accessible upright lateral side portion of the filtering compartment for selectively opening and closing the lateral access openings for ingress and egress of the upright tubular filters to permit insertion, removal, inspection and/or maintenance of the upright tubular filters. In the illustrative embodiment, the upright side access doors open in a direction away from the sound attenuating device, motor, and tangential separator. The upright side access doors can include a right side door that opens from left to right and a left side door that opens from right to left. The upright side access doors can comprise lateral metal doors providing substantially dust impervious and imperforate barriers. The upright side access doors preferably have upper sections that are positioned at a level higher than the solids-gas separation compartment and can have a lower generally horizontal pivotal flange 91. Each door can have a generally planar or flat front surface that in flush and aligned with the exterior surface of the accessible side portion of the filtering compartment.

In some circumstances, it may be desirable that the side doors comprise removable panels or that more or less side doors be used or that the side door be curved with a curved convex front surface that can be flush and/or aligned with the curved exterior surface of a curved upright portion of the filtering compartment. As shown in FIG. 1, the filter door system of the filtering compartment can include a pair of generally horizontal locking bars 92-93 providing lateral braces extend laterally and across the side doors 90. The locking bars can include an upper locking bar 92 and a lower locking bar 94. The locking bars can be pivotally hinged to the side doors by pivot pins 94. Each of the locking bars can be detachably connected to the accessible side portion 85 of the filtering compartment in proximity to the access opening 88. A pair of substantially parallel upright bars 96-97 can extend vertically between and can be secured to and be rigidly connected to the upper and lower locking bars. In the illustrative embodiment, each of the locking bars has door bracket comprising a manually graspable (grippable) pivotal locking handle 98 providing a door pull with a latch 100. The handle and latch are moveable from: (a) a closed locking position for locked and securing the locking bars and the upright side doors, to (b) an unlocked open position for unlocking the locking bars and upright side doors.

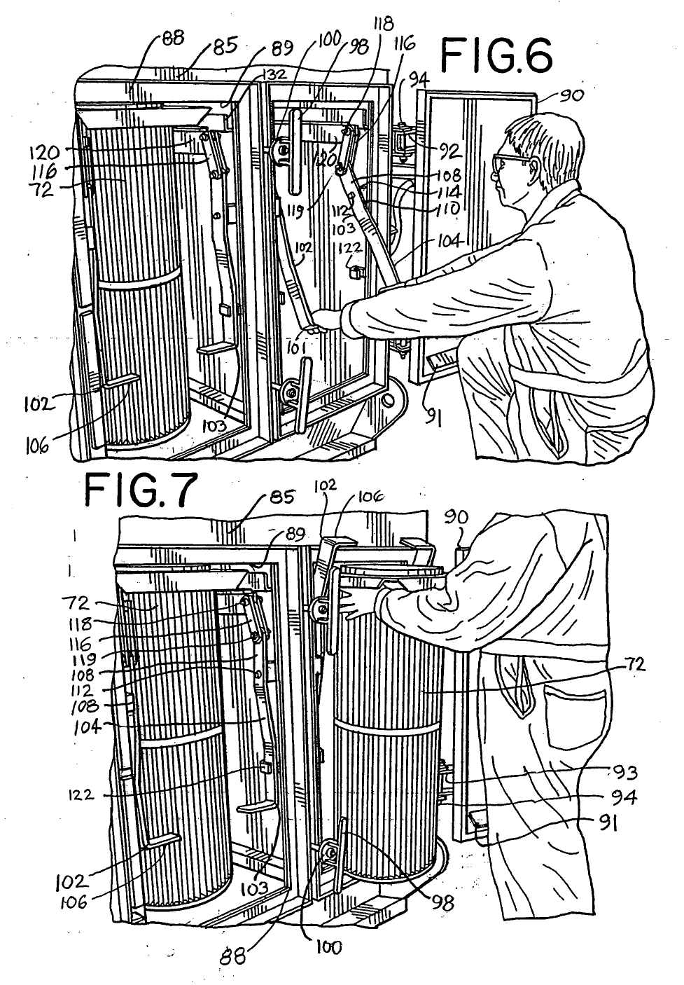

As shown in FIGS. 6-7, the filtering compartment can have a filter lifting and/or moving mechanism 101 with complementary articulated arms 102-103 including a left arm 102 and a right arm 103. Each filter arm can be moveable, pivotal, or swingable, between: (a) a closed locked position, as shown in the left portions of FIGS. 6-7, for lowering, clamping, and preventing removal of the upright tubular filter and (b) an open position after the upright side door is opened, as shown in the right portions of FIGS. 6-7, for lifting (raising) and permitting removal or replacement of the upright tubular filter. Each of the arms is generally L-shaped with an elongated portion 104 that extends generally upwardly when the arm is in the upright closed position and a shorter manually graspable lateral portion 106 that extends generally horizontally and is cantilevered from the upright portion 104 for providing an abutment stop between the upright tubular filter and the upright side door when the arm is in the upright closed position. The elongated portion can be slightly bent with an upper section 108 (FIG. 6) and a longer lower section 110 that can extend further laterally outwardly and away from the filter than the short upper section 108. The intermediate central portion of the upper section 108 can be pivotally connected via a pivot pin 112 to an end bar 114 providing a bracket. A pair of upper pivotal bars 116 providing an upper bracket can extend between and can be pivotally connected by pivot pins 118-119 to an upper end bar 120 or frame connected to the far end of the housing. The left arm is generally L-shaped as viewed from the front and the right arm is generally L-shaped as viewed from the back or interior of the filter compartment. Hook-shaped lateral brackets 122 can be secured to the accessible side portion of the filtering compartment in proximity to the lateral access opening for abuttingly engaging and holding the elongated portion of the arm when the arms are in the upright closed position. A gasket can be positioned between the housing plate and the filter to seal the filter.

The sides filter opening, side doors, locking bars, and arms, and related equipment, as described above provide a filter door assembly and system which safely secures, clamps, and locks the filters within the filter compartment during operation of the vacuum loader, but yet can be readily opened for easy and convenient access to the interior of the filter compartment for efficient insertion, removal, inspection, and/or maintenance of the filters.

Among the many advantages of the preceding industrial vacuum loaders comprising dust collectors, pneumatic conveyors, vacuum conveyors, and industrial vacuum cleaners are:
1. Superior vacuuming and removal of dust, particulate matter, debris and waste.
2. Convenient filter side doors for ready ingress and egress of the filters in the filter compartment to permit easy insertion, removal, inspection, or maintenance of the filters.
3. An outstanding filter door system.
4. Better solids-gas separation.
5. Enhanced air purification.
6. Excellent dedusting.
7. Greater efficiency of operation.
8. More economical to manufacture and operate.
9. Enhanced air purification.
10. Greater decreased operator exposure to dust.
11. Good load-carrying collection capacity.
12. Flexibility and better adaptability for moveable, towable, portable and stationary operations.
13. Superb performance.
14. Easy to use.
15. Dependable.
16. Quieter operation.
17. Easy to install, remove and repair.
18. Less maintenance.
19. Economical.
20. Efficient.
21. Effective.

Although embodiments of the invention have been shown and described, it is to be understood that various modifications and substitutions, as well as rearrangements of parts, components, equipment, apparatus and process steps, can be made by those skilled in the art without departing from the novel spirit and scope of this invention.

What is claimed is:

1. A vacuum loader providing an industrial vacuum cleaner, dust collector, or vacuum conveyor, for removing or transfer of particulate material, comprising:
a hopper comprising a bin;
a solids-gas separation compartment for making a gross cut separation of larger particulates of dust from influent dusty air laden with particulate material, said solids-gas separation compartment having an open bottom positioned above and communicating with said bin to discharge larger particulates of dust into said bin, said solids-gas separation compartment having an inlet port connected to at least one primary inlet conduit and at least one outlet port for discharging a partially dedusted gas stream; and
at least one filtering compartment communicating with said outlet port of said solids-gas separation compartment, said filtering compartment having a top portion, a bottom portion, and at least one upright portion extending between and connecting said top portion and said bottom portion, said filtering compartment having at least one filter disposed within an interior of the filtering compartment for filtering and removing most smaller particulates of dust comprising fines remaining in the partially dedusted gas stream, said filtering compartment defining an outlet for discharging the filtered air, said bottom portion of said filtering compartment having a discharge opening providing an open bottom positioned above the bin for discharging filtered particulates of dust into the bin, said side portion of said filtering compartment having a lateral access opening for accessing said filter, and a side door operatively secured to said upright portion of said filtering compartment and communicating with said lateral access opening of said upright portion of said filtering compartment for selectively opening and closing said lateral access opening for ingress and egress of said filter to permit insertion, removal, inspection, or maintenance of said filter.

2. A vacuum loader in accordance with claim 1 wherein:
said side door is generally rectangular or curved;
said side door opens right to left or clockwise, or opens left to right or counterclockwise or can be manually removed; and
said side door is spaced laterally away from said solids-gas separation compartment; and
said filter is selected from the group consisting of a tubular filter, a Hepa-type filter, a bag filter, a star filter a box-type filter, envelope filter, flat filter, conical filter, cartridge filter, and canister filter.

3. A vacuum loader in accordance with claim 1 wherein:
said side door comprises a upright lateral door or a door that is positioned at an angle of inclination to the bottom portion of the filtering compartment; and
said side door comprises a substantially dust impervious and imperforate barrier.

4. A vacuum loader in accordance with claim 1 wherein:
said side door comprises a metal door;
at least a portion of said side door is positioned at a level higher than said solids-gas separation compartment; and
said door has retaining clamps for sealing the filter housing.

5. A vacuum loader in accordance with claim 1 wherein said side door is hinged and pivotally connected to the side portion of the filtering compartment.

6. A vacuum loader in accordance with claim 1 including a locking bar extending laterally and entirely across said side door for locking and securing said door in a closed position.

7. A vacuum loader in accordance with claim 1 including:
at least one filter lifting or moving mechanism; and
said solid separation compartment comprises at least one louver.

8. A vacuum loader providing an industrial vacuum cleaner, dust collector, or vacuum conveyor, for removing or transfer of particulate material, comprising:
a frame assembly for receiving a hopper comprising a bin, said frame assembly providing a support platform;
a primary inlet conduit providing a flexible vacuuming hose or metal tubing for removing and collecting particulates of dust from particulate material in an area surrounding the vacuum loader;
a vacuum pump comprising a blower and motor mounted on said support platform and connected to a blower line for drawing influent dusty air laden with particulates of dust from particulate material through said at least one primary inlet conduit;
a sound attenuating device connected to said vacuum pump for attenuating and decreasing noise and vibrations from said vacuum pump;
a solids-gas separation compartment secured to said frame assembly and comprising a separator for making a gross cut separation of larger particulates of dust from influent dusty air laden with particulate material from the primary inlet, said solids-gas separation compartment having an open bottom positioned above and communicating with said bin to discharge larger particulates of dust into said bin, said solids-gas separation compartment having an inlet port connected to said primary inlet conduit and outlet ports for discharging a partially dedusted gas stream;
at least one filtering compartment spaced laterally away and offset from said solids-gas separating compartment and communicating with said outlet port of said solids-gas separation compartment, said filtering compartment having a top portion, a bottom portion, and upright side portions extending upwardly between and connecting said top portion and said bottom portion, upright filters located within an interior of the filtering compartment for filtering and removing most smaller particulates of dust comprising fines remaining in the partially dedusted gas stream, said filtering compartment having an outlet for discharging the filtered air to said blower line of the vacuum pump for discharging the filtered air into the surrounding area, said bottom portion of said filtering compartment having a discharge opening providing an open bottom positioned above the bin for discharging filtered particulates of dust into the bin, at least one of said upright side portions of said filtering compartment comprising an accessible side portion with a filter door system comprising at least one upright opening for accessing said upright filter, and said filter door system comprising at least one upright door operatively connected to said accessible side portion of said filtering compartment and communicating with at least a portion of said lateral access opening of said side portion of said filtering compartment for selectively opening and closing at least a portion of said upright opening for ingress and egress of said filter to permit insertion, removal, inspection, or maintenance of said filter.

9. A vacuum loader in accordance with claim 8 wherein:
said upright side door and access opening is positioned laterally opposite from said sound attenuating device, motor, and separator;
said upright side door opens in a direction away from said sound attenuating device, motor, and separator;
said upright side door comprises a lateral metal door; and
said upright side door comprises a substantially dust impervious and imperforate barrier.

10. A vacuum loader in accordance with claim 8 wherein said filter door system comprises:
at least one filter lifting or moving mechanism; and
at least one generally horizontal locking bar extending laterally and entirely across said side door;
said locking bar being detachably connected to said accessible side portion of said filtering compartment in proximity to said access opening;
said locking bar having a manually grippable pivotal handle operatively connected to a latch; and
said handle and latch being moveable from a closed locked position for locking and securing said locking bar and said upright side door, to an unlocked open position for unlocking said locking bar and upright side door.

11. A vacuum loader in accordance with claim 8wherein said separator comprises a louvered cyclone separator.

12. A vacuum loader providing an industrial vacuum cleaner, dust collector, or vacuum conveyor, for removing transfer of particulate material, comprising:
a frame assembly for receiving a hopper comprising a bin, said frame assembly providing a support platform;
a primary inlet conduit providing a flexible vacuuming hose or metal tubing for removing and collecting particulates of dust from particulate material in an area surrounding the vacuum loader;
a vacuum pump comprising a blower and motor mounted on said support platform and connected to a blower line for drawing influent dusty air laden with particulates of dust from particulate material through said primary inlet conduit;
a sound attenuating device connected to said vacuum pump for attenuating and decreasing noise and vibrations from said vacuum pump;
a solids-gas separation compartment secured to said frame assembly and comprising a tangential cyclone separator for making a gross cut separation of larger particulates of dust from influent dusty air laden with particulate material from the primary inlet, said solids-gas separation compartment having an open bottom positioned above and communicating with said bin to discharge larger particulates of dust into said bin, said solids-gas separation compartment having an inlet port connected to said primary inlet conduit and at least one outlet port for discharging a partially dedusted gas stream;
at least one filtering compartment spaced laterally away and offset from said solids-gas separating compartment and communicating with said outlet port of said solids-gas separation compartment, said filtering compartment having an imperforate top portion, a bottom portion, and upright side portions extending generally vertically between and connecting said imperforate top portion and said bottom portion;
said upright side portions comprising a motor-facing side portion facing said solids-gas separating compartment and said sound attenuating device, an accessible side portion positioned opposite said motor-facing portion, and opposite facing injector supporting side portions extending between and connected to said motor-facing side portion and said accessible side portion;
an array of upright tubular filters within an interior of the filtering compartment for filtering and removing most smaller particulates of dust comprising fines remaining in the partially dedusted gas stream;
reverse pulse filter cleaners comprising air injectors mounted on said injector side portions of said filtering compartment and extending into to the interior of said filtering compartment for periodically injecting intermittent blasts comprising pulses of compressed air upon the upright tubular filters to help clean the upright tubular filters;
an air supply source comprising at least one compressed air tank or air canister mounted on said injector side portions of said filtering compartment and pneumatically connected to said air injectors for providing compressed air to said reverse pulse filter cleaners;
said motor-facing portion of said filtering compartment having an outlet communicating with the blower line for discharging the filtered air to the blower line into the vacuum pump to discharge the filtered air into the surrounding area;
said bottom portion of said filtering compartment having a discharge opening providing an open bottom positioned above the bin for discharging filtered particulates of dust into the bin;
said accessible side portion of said filtering compartment comprising a filter door system defining upright, similar size, laterally aligned, rectangular lateral access openings for accessing said upright tubular filters; and
said filter door system further comprising a set of laterally aligned, similar size, upright side access doors pivotally connected and hinged to said accessible side portion of said filtering compartment and communicating with said lateral access openings of said side portion of said filtering compartment for selectively opening and closing said lateral access openings for ingress and egress of said upright tubular filters to permit insertion, removal, inspection, or maintenance of said upright tubular filters.

13. A vacuum loader in accordance with claim 12 wherein:
said upright side access doors open in a direction away from said sound attenuating device, motor, and tangential separator;
said upright side access doors including a right side door that opens from left to right and a left side door that opens from right to left; or manually removable doors; and
said upright side access doors comprise lateral metal doors providing substantially dust impervious and imperforate barriers.

14. A vacuum loader in accordance with claim 13 wherein said filter door system includes:
a pair of generally horizontal locking bars extending laterally and entirely across said side doors;
said locking bars being pivotally hinged to said side doors;
said locking bars including an upper locking bar and a lower locking bar;
substantially parallel upright bars extending vertically between and securing and rigidly connected said upper and lower locking bars;
each of said locking bars being detachably connected to said accessible side portion of said filtering compartment in proximity to said access openings;
each of said locking bars having a manually grippable pivotal handle with a latch; and
said handle and latch being moveable from a closed locked position for locking and securing said locking bars and said upright side doors, to an unlocked open position for unlocking said locking bars and upright side doors.

15. A vacuum loader in accordance with claim 12 including at least one filter lifting or moving mechanism.

16. A vacuum loader in accordance with claim 12 wherein said:
filtering compartment comprises multiple filtering compartments; and
each of multiple filtering compartments are spaced laterally away and offset from said solids-gas separating compartment.

17. A vacuum loader in accordance with claim 12 wherein said tangential cyclone separator comprises a perforated tangential cyclone separator with a housing having a foraminous wall comprising an upright perforated curved wall plate.

18. A vacuum loader in accordance with claim 17 wherein:
said upright perforated curved wall plate defines angular perforations extending entirely through said foraminous wall at an angle of inclination surfaces for exiting partially dedusted fluid at said angle of inclination from said perforated tangential cyclone separator to said upright tubular filters in said filtering compartment;
said angular perforations are selected from the group consisting of: an array, set, series, group, pattern, symmetrical pattern, asymmetrical pattern, uniform pattern, matrix, curved rows, parallel rows, and aligned rows of vent holes, through holes, apertures, passageways, radial openings, slanted openings, slits, slots, offset holes, fluid outlet ports, circular holes, elliptical holes, square holes, triangular holes, rectangular holes, polygonal holes, drilled holes, punched holes, louver slots, and perforated vanes; and
said angular perforations are arranged in rows selected from the group consisting of curved rows, parallel rows, staggered rows, offset rows, and aligned rows.

19. A vacuum loader in accordance with claim 12 wherein said tangential cyclone separator comprises a louvered tangential cyclone separator comprising a circular array of aliquotly spaced upright slats providing louvers.
